(19) United States
(12) Patent Application Publication
(10) Pub. No.: US 2026/0323209 A1
(43) Pub. Date: Oct. 15, 2026

(54) ENHANCED AUDIO SOURCE TRACKING FOR MICROPHONE ARRAYS

(71) Applicant: Shure Acquisition Holdings, Inc., Niles, IL (US)

(72) Inventors: Xuanyi Yang, Chicago, IL (US); Dusan Veselinovic, Chicago, IL (US)

(21) Appl. No.: 19/558,883

(22) Filed: Mar. 6, 2026

Related U.S. Application Data
(60) Provisional application No. 63/767,815, filed on Mar. 6, 2025.

(51) Int. Cl. H04R 3/00; H04N 23/60; H04R 1/40

(52) U.S. Cl. CPC H04R 3/005; H04N 23/64; H04R 1/406

(57) ABSTRACT

Techniques are disclosed herein for providing enhanced audio source tracking utilizing elevation angle correction and/or temporal smoothing for a microphone array. Examples may include determining audio localization data associated with a source of interest within an environment based on an audio stream captured by at least one audio capture device of a microphone array, generating tuned audio localization data for the source of interest based on applying a defined elevation angle correction for the microphone array to the audio localization data, determining audio source tracking data for the source of interest based on the tuned audio localization data, and outputting the audio source tracking data to an output device communicatively coupled to the microphone array.

### CROSS REFERENCE TO RELATED APPLICATIONS

This application claims the benefit of U.S. Provisional Patent Application No. 63/767,815, titled “ENHANCED AUDIO SOURCE TRACKING FOR MICROPHONE ARRAYS,” and filed on Mar. 6, 2025, the entirety of which is hereby incorporated by reference.

### TECHNICAL FIELD

Embodiments of the present disclosure relate generally to audio processing and, more particularly, to systems configured to provide audio source tracking via a beamforming microphone array.

### BACKGROUND

Microphone arrays have become increasingly prevalent in various audio processing applications and typically utilize multiple microphones to capture, process and track audio from different sources within an audio environment. However, Applicant has identified a number of deficiencies associated with audio source tracking using beamforming lobes of a microphone array.

### BRIEF SUMMARY

Various embodiments of the present disclosure are directed to apparatuses, systems, methods, and computer readable media for providing enhanced audio source tracking utilizing elevation angle correction and/or temporal smoothing for a microphone array. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example audio processing system configured to execute audio source tracking operations in accordance with one or more embodiments disclosed herein;

FIG. 2 illustrates an example audio processing apparatus configured in accordance with one or more embodiments disclosed herein;

FIG. 3 illustrates an example audio processing pipeline associated with enhanced audio source tracking enabled by an audio source tracking system in accordance with one or more embodiments disclosed herein;

FIG. 4 illustrates an example temporal smoothing pipeline associated with temporal smoothing enabled by an audio source tracking system in accordance with one or more embodiments disclosed herein;

FIG. 5 illustrates an example audio environment associated with enhanced audio source tracking enabled by an audio source tracking system in accordance with one or more embodiments disclosed herein;

FIG. 6 illustrates an example system associated with a microphone array in accordance with one or more embodiments disclosed herein;

FIG. 7 illustrates an example method for providing enhanced audio source tracking in accordance with one or more embodiments disclosed herein; and

FIG. 8 illustrates an example graph associated with localizations for a microphone array in accordance with one or more embodiments disclosed herein; and

FIG. 9 illustrates an example graph associated with correcting an elevation angle for a localization calculated for a microphone array in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

An audio system for capturing audio within an audio environment may contain a microphone array, a beamforming module, and/or other digital signal processing (DSP) elements. For certain audio systems, a beamforming module may be configured with audio source tracking functionality to enable localization and/or real-time tracking of one or more audio sources within an audio environment. A microphone array is an audio capture device that consists of two or more microphones positioned in a predefined geometric configuration such as a linear, circular, or planar geometric configuration. A microphone array may also include beamforming lobes generated via signal processing that are applied to the output of the two or more microphones. The beamforming lobes may be directed to capture audio at fixed locations within an audio environment. For example, a beamforming lobe may be configured to focus sensitivity of audio capture for the microphone array toward an audio source by adjusting phase, amplitude, and/or other audio characteristics of signals from individual microphones.

Audio source tracking functionality associated with the microphone array may utilize a spatial distribution of the microphones and/or beamforming lobes of the microphone array to capture differences in the arrival time, amplitude, or other signal characteristics of audio signals captured from various directions within the audio environment. By analyzing variations in audio signals captured by different microphones and/or different beamforming lobes of the microphone array, the audio source tracking functionality may determine position(s) of audio sources relative to the microphone array. In an example, respective microphones of the microphone array may be located at fixed positions within an audio environment and may employ beamforming to capture audio from one or more sources of audio. Additionally, the microphone array may incorporate audio source tracking functionality to enable the beamforming lobes of the microphone array to dynamically track one or more audio sources within an audio environment.

In addition to a number of microphones utilized by a microphone array, a size and/or shape of a microphone array may affect the spatial distribution of the microphones and/or beamforming lobes. A microphone array may be constructed with a particular size and/or to accommodate a particular audio application. As the demand for more compact and versatile audio capture systems increases for audio applications such as videoconferencing, it is becoming increasingly desirable to decrease the size of a microphone array. For example, a smaller microphone array may be desirable for a videoconferencing application such that the microphone array may be mounted unobtrusively in a ceiling of a rooms, making the microphone array less visually intrusive and more adaptable to the audio environment for the videoconferencing application.

However, the reliability of tracking of the audio source typically depends on a sufficiently sized microphone array for a particular audio sample rate. Additionally, the size and/or shape of a microphone array may affect the spatial resolution and/or beamforming capabilities of the microphone array for audio source tracking. For example, decreasing the radius of a microphone array results in a smaller effective area of the microphone array for audio capture such that accuracy and stability of the audio capture may decrease when the audio source is located outside of the effective area of the microphone array for the audio capture. As such, reducing a size and/or altering a shape of a microphone array may result in technical challenges for maintaining accurate audio source tracking, particularly for audio sources located at an edge or outside a coverage area of the microphone array. Thus, less desirable audio systems that utilize a microphone array may be incapable of accurately capturing and/or processing audio data for particular audio sources in an audio environment, resulting in inefficiencies and/or inaccuracies with respect to the microphone array. It is therefore desirable to improve audio capture functionality for microphone arrays in an audio environment.

To address these and/or other technical problems associated with traditional audio systems that utilize a microphone array, various embodiments disclosed herein provide enhanced audio source tracking utilizing elevation angle correction and/or temporal smoothing for a microphone array. For example, the enhanced audio source tracking may enhance performance of a microphone array, particularly microphone arrays with reduced size for an audio environment, by providing improved localization and/or tracking of audio sources in an audio environment. In some examples, a multi-stage audio processing pipeline may be supplemented with elevation angle correction, dynamic cluster smoothing, and/or temporal smoothing to enable the enhanced audio source tracking. The elevation angle correction mechanism may apply a predefined correction factor to localization information provided by the acoustic localization for an audio source within an audio environment to compensate for potential inaccuracies in elevation angle estimation which is especially prevalent in compact microphone arrays. The dynamic clustering may group and/or track an audio source within the audio environment. Additionally, the dynamic clustering and/or the temporal smoothing may be utilized to stabilize location estimates over time.

Accordingly, the multi-stage audio processing pipeline for providing enhanced audio source tracking may improve accuracy and/or reliability of audio source tracking of an audio source in an audio environment. The enhanced audio source tracking disclosed herein is particularly beneficial for audio applications, such as video conferencing system, where a compact microphone array is desirable for an audio environment.

### Exemplary Audio Source Tracking Systems and Methods

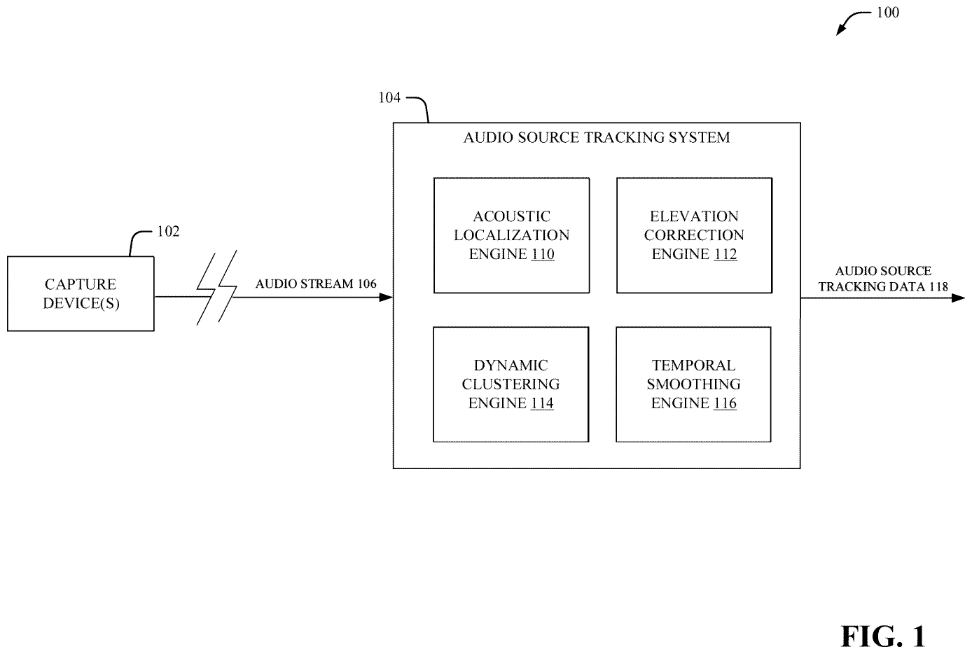

FIG. 1 illustrates an audio signal processing system 100 that is configured to provide enhanced audio source tracking utilizing elevation angle correction and/or temporal smoothing for a microphone array associated with an audio environment, according to embodiments of the present disclosure. The audio signal processing system 100 may be, for example, a conferencing system (e.g., a conference audio system, a video conferencing system, a digital conference system, etc.), a classroom microphone system, a lecture hall microphone system, an audio performance system, an audio recording system, a music performance system, a music recording system, a digital audio workstation, a broadcasting microphone system, an augmented reality system, a virtual reality system, an online gaming system, or another type of audio system. Additionally, the audio signal processing system 100 may be implemented as an audio signal processing apparatus and/or as software that is configured for execution on a digital conference system, an audio conferencing processor, a wireless conference unit, an audio workstation device, a laptop, a personal computer, a smartphone, an augmented reality device, a virtual reality device, a recording device, headphones, earphones, speakers, or another device. The audio signal processing system 100 disclosed herein may additionally or alternatively be integrated into a virtual DSP processing system (e.g., DSP processing via virtual processors or virtual machines) with other conference DSP processing.

The audio signal processing system 100 may utilize the enhanced audio source tracking to provide various improvements related to audio processing and/or beamforming such as, for example, to: improve accuracy of audio source tracking of an audio source in an audio environment, improve accuracy of an elevation angle estimation for a microphone array, improve precision of audio localization for an audio source in an audio environment, improve stability and reliability of location estimates for an audio source in an audio environment, enable simultaneous tracking of audio sources in an audio environment, improve performance for a smaller microphone array to enable audio source tracking capabilities comparable to a larger microphone array, enable efficient real-time audio processing related to an audio source in an audio environment, dynamically configure individual beamforming lobes of a microphone array associated with an audio environment based on a tracked location of an audio source within an audio environment, improve beamforming accuracy associated with a microphone array, improve efficiency of deploying a microphone array in an audio environment, improve selection of a beamforming scheme for optimal beamforming related to a microphone array associated with an audio environment, and/or improve one or more other beamforming processes related to a microphone array.

As disclosed herein, an audio environment may be an indoor environment, an outdoor environment, a room (e.g., a conference room or another room in an indoor environment), a lecture hall, a performance hall, an auditorium, a broadcasting environment, a sports stadium or arena, a virtual environment, or another type of audio environment. In various examples, the audio signal processing system 100 may be configured to optimize audio capture and/or audio source tracking associated with one or more beamforming lobes of a microphone array via digital signal processing. In some examples, the audio signal processing system 100 may be additionally or alternatively configured to optimize audio capture and/or audio source tracking associated with one or more beamforming lobes via machine learning and/or by utilizing one or more trained machine learning models. The audio signal processing system 100 may also be employed for another type of audio processing application such as, but not limited to, noise reduction, acoustic echo cancelation, active noise cancelation, adaptive noise cancelation, etc.

The audio signal processing system 100 includes one or more capture devices 102. The one or more capture devices 102 may respectively be audio capture devices configured to capture audio from one or more sound sources. The one or more capture devices 102 may include one or more sensors configured for capturing audio by converting sound into one or more electrical signals. The one or more sensors may be arranged in a specific geometric pattern to enable improved audio capture via the one or more capture devices 102. For instance, the one or more sensors may be arranged in a specific geometric pattern to enable an improved directionality, coverage area, and/or spatial resolution for audio capture via the one or more capture devices 102. In some examples, the one or more sensors may be arranged in a specific geometric pattern to enable improved localization and/or beamforming via the one or more capture devices 102. In an example, a geometric pattern for the one or more sensors may include a circular pattern. In another example, a geometric pattern for the one or more sensors may include a square pattern or a rectangular pattern. In yet another example, a linear pattern for the one or more sensors may include a rectangular pattern. However, it is to be appreciated that, in certain examples, the one or more sensors may include a different geometric pattern. Additionally, the one or more sensors may be positioned in a planar configuration or a three-dimensional configuration. The audio captured by the one or more capture devices 102 may also be converted into an audio stream 106. The audio stream 106 may comprise a digital audio data or, alternatively, analog audio data, related to the one or more electrical signals. In some examples, the audio stream 106 may comprise an audio portion of a video stream captured by the one or more capture devices 102.

In an example, the one or more capture devices 102 are one or more microphones arrays. For example, the one or more capture devices 102 may correspond to a microphone array, one or more microphones of a microphone array, one or more beamformed lobes of a microphone array, one or more circular microphones of a microphone array, one or more linear microphones of a microphone array, one or more ceiling microphone arrays, one or more table microphone arrays, or another type of microphone arrays. In alternate examples, the one or more capture devices 102 are another type of capture device such as, but not limited to, one or more condenser microphones, one or more micro-electromechanical systems (MEMS) microphones, one or more dynamic microphones, one or more piezoelectric microphones, one or more virtual microphones, one or more network microphones, one or more ribbon microphones, and/or another type of microphone configured to capture audio. It is to be appreciated that, in certain examples, the one or more capture devices 102 may additionally or alternatively include one or more video capture devices, one or more infrared capture devices, one or more sensor devices, and/or one or more other types of audio capture devices.

The one or more capture devices 102 may be positioned within a particular audio environment or proximate to a particular audio environment. In some examples, the one or more capture devices 102 may be associated with a coverage area of an audio environment. For example, the one or more capture devices 102 may be located within the coverage area or proximate to the coverage area to enable capture of at least a portion of the audio stream 106 via the coverage area. In some examples, the audio stream 106 includes audio captured from two or more coverage areas within an audio environment. For instance, the audio stream 106 may include mixed audio associated with two or more coverage areas. A coverage area may be an area within an audio environment that is associated with one or more audio sources. For example, a coverage area may be an area of space within an audio environment from which audio pickup is desirable. A coverage area may be derived automatically by the audio source tracking system 104. Alternatively, a coverage area may be user-specified via a user interface. In some examples, a room may be associated with one or more coverage areas that include one or more conference tables but exclude sources of noise such as heating, ventilation, and air conditioning (HVAC) systems, doors, etc.

The audio signal processing system 100 also includes an audio source tracking system 104. The audio source tracking system 104 may include one or more processing engines configured to process the audio stream 106. As illustrated in FIG. 1, the audio source tracking system 104 includes an acoustic localization engine 110, an elevation correction engine 112, a dynamic clustering engine 114, and/or a temporal smoothing engine 116.

The acoustic localization engine 110 may process the audio stream 106 to determine audio localization data associated with a source of interest within an environment. The source of interest may be an audio source, a sound source, a speaker, or another type of source of interest within the environment. The audio localization data may include one or more parameters that characterize spatial properties of detected sources of interest associated with the audio stream 106. In some examples, the audio localization data may include, but is not limited to: time difference of arrival (TDOA) information representative of the relative timing differences of audio signals reaching different microphones in the microphone array, azimuth and elevation angle estimates representative of the horizontal and vertical angular positions of sources of interest relative to the microphone array, initial coordinate estimates for a source of interest representative of approximate spatial locations of detected sources of interest, confidence metrics associated with the estimated locations, probability distributions associated with the estimated locations, and/or other audio localization data. In some examples, the acoustic localization engine 110 may generate the audio localization data at regular intervals or triggered by the detection of defined audio events to provide a continuous stream of spatial information for subsequent processing stages of the audio source tracking system 104.

The audio localization data generated by the acoustic localization engine 110 may be provided as input to the elevation correction engine 112. The elevation correction engine 112 may adjust elevation angle data associated with the audio localization data. The elevation angle data may include an initial elevation angle for the source of interest that is estimated by the acoustic localization engine 110 as part of the audio localization process. However, the initial elevation angle may be associated with a potential error, particularly for low elevation angles associated with audio capture near or outside an effective area of the capture device 102 that captures the audio stream 106. As such, the elevation correction engine 112 may apply one or more predefined corrections to the audio localization data to improve accuracy of the localization estimate provided by the acoustic localization engine 110.

The elevation correction engine 112 may also be utilized to improve the precision of elevation angle calculations by applying a correction factor that compensates for a systematic underestimation of elevation angles, thereby enabling a compact microphone array to achieve elevation angle accuracy comparable to a larger microphone array that comprises additional hardware or increased physical dimensions as compared to the compact microphone array.

In some examples, the elevation correction engine 112 may apply a defined elevation angle correction to the audio localization data to generate tuned audio localization data. The defined elevation angle correction may be defined for a particular capture device 102 that captures the audio stream 106. For example, the defined elevation angle correction may be defined for a particular microphone array that captures the audio stream 106. In some examples, the defined elevation angle correction may be determined based on a size of the particular microphone array.

Additionally, the elevation angle correction may be determined based on real-time measurements associated with a microphone array. For example, a single dimension of direction of arrival angle may be estimated for a linear microphone array. The dimension of direction of arrival angle for the linear microphone array may include an azimuth or elevation angle based on an orientation of the linear microphone array (e.g., horizontal or vertical). As such, a correction may be applied to an azimuth or elevation angle for a linear microphone array. In another example, two-dimensional or three-dimensional locations may be estimated for a circular microphone array. For instance, a correction may be applied to the elevation angle of a circular microphone array. As such, a specific configuration for a microphone array may impact estimation of the elevation angle correction.

In some examples, the defined elevation angle correction may be based on a predetermined relationship between original elevation angles and corrected elevation angles for the particular microphone array. For example, an original elevation angle may be linearly modified to a corrected elevation angle via a mapping process associated with the predetermined relationship. In some examples, the following correction equation may be utilized by the elevation correction engine 112:

newElev=C*oldElev−45*(oldElev−1)

where newElev corresponds to a corrected elevation angle, oldElev corresponds to an original elevation angle, and C corresponds to a defined elevation angle correction. In some examples, the correction equation may apply a linear transformation to the original elevation angle oldElev based on the defined elevation angle correction C. The value of the defined elevation angle correction C may be determined empirically for a particular microphone array based on calibration measurements and/or geometric properties of the microphone array. In some examples, a lookup table may be utilized via the mapping process to enable determination of a corrected elevation angle based on an original elevation angle and a defined elevation angle correction.

Additionally, the defined elevation angle correction may be utilized to compensate for systematic errors in the audio localization data, particularly for low elevation angles for a compact microphone array. In some examples, the elevation correction engine 112 may utilize the defined elevation angle correction to compensate for limitations in the TDoA measurements associated with low elevation angles.

In some examples, the elevation correction engine 112 may apply the defined elevation angle correction to counteract an underestimated distance for a source of interest when the source of interest is positioned outside an effective area of the microphone array. In some examples, the elevation correction engine 112 may analyze a statistical distribution of localization points over time to identify and/or correct systematic errors in elevation angle estimation. In some examples, the elevation correction engine 112 may enhance the accuracy of three-dimensional audio source tracking such as for compact microphone arrays where spatial resolution may be inherently limited due to reduced size of the microphone array. As such, the tuned audio localization data may more accurately represents true spatial positions of the source of interest as compared to the audio localization data provided by the acoustic localization engine 110.

The dynamic clustering engine 114 may determine audio source tracking data 118 for the source of interest based on the tuned audio localization data. In some examples, the dynamic clustering engine 114 may process the tuned audio localization data to generate clustered localization data associated with the source of interest. Additionally, the dynamic clustering engine 114 may determine the audio source tracking data 118 based on the clustered localization data. In some examples, the dynamic clustering engine 114 may be utilized for spatial smoothing of the tuned audio localization data. For instance, the dynamic clustering engine 114 may smooth and/or refine the tuned audio localization data. Additionally or alternatively, the dynamic clustering engine 114 may filter outlier and/or erroneous data points from the tuned audio localization data. The temporal smoothing engine 116 may apply temporal smoothing to the audio source tracking data 118 to generate an updated version of the audio source tracking data 118 (e.g., updated audio source tracking data) for the source of interest. For example, the temporal smoothing engine 116 may refine and/or stabilize a location estimate for the source of interest after an elevation correction process and/or a dynamic cluster smoothing processes is applied to the audio stream 106 to provide the updated version of the audio source tracking data 118. As such, the updated version of the audio source tracking data 118 may provide optimized location information with improved accuracy. In some examples, the updated version of the audio source tracking data 118 may include an optimized set of location coordinates for the source of interest.

In some examples, the dynamic clustering engine 114 may assign the source of interest to a particular cluster within the environment. For instance, the dynamic clustering engine 114 may assign the source of interest to a particular cluster based on audio localization data to track sources of interests, such as talkers, in the audio environment in real-time. In some examples, the dynamic clustering engine 114 may process the audio localization data to track multiple sources of interests within the environment. In some examples, the dynamic clustering engine 114 may group closely positioned localization data points into clusters corresponding to one or more sources of interest within the audio environment. The clusters may be dynamically updated as new localization data becomes available, allowing for smooth and continuous tracking of moving sources of interest.

In some examples, the dynamic clustering engine 114 may utilize one or more clustering techniques to manage the clusters, including but not limited to, creating new clusters for newly detected sources, merging clusters that come into close proximity, and/or removing clusters that become inactive over time. In some examples, the dynamic clustering engine 114 may be utilized to enhance the ability of the audio source tracking system 104 to distinguish between multiple sources of interest in complex acoustic environments, even when sources of interest are in motion or when new sources of interest are identified in the audio environment. In some examples, the dynamic clustering engine 114 may output clustered localization data that represents a current state and/or position of tracked sources of interest, which may then be further refined by subsequent processing stages of the audio source tracking system 104.

In some examples, raw localization data points generated by the acoustic localization engine 110 may exhibit spatial variance due to noise, reverberation, and/or multipath reflections within the audio environment. As such, without utilizing dynamic clustering, individual localization data points may fluctuate between consecutive measurements, resulting in unstable tracking of the source of interest. The dynamic clustering engine 114 may therefore address this technical limitation by aggregating spatially related localization data points into clusters, thereby reducing the impact of individual erroneous measurements and/or providing an improved representation of the location of the source of interest. By dynamically managing clusters based on incoming localization data, the dynamic clustering engine 114 may also enable improved tracking of moving sources of interest.

A cluster may be a group of data points or measurements associated with a particular audio source or region within the audio environment. In the context of audio source tracking, a cluster may represent a collection of localization data points that are spatially and/or temporally related. In some examples, a cluster may correspond to a single audio source or a group of closely positioned audio sources within the audio environment. Clusters may be dynamically formed, updated, and/or managed based on audio localization data provided by the acoustic localization engine 110. Additionally, a cluster may be associated with an interval of time to facilitate continuous tracking of audio sources within the audio environment. Properties of a cluster may include, but are not limited to, a central location, spatial boundaries, temporal duration, and/or associated confidence metrics.

In some examples, the dynamic clustering engine 114 may dynamically manage clusters based on incoming localization data points provided by an audio stream such that clusters are generated and/or merged using the incoming localization data points. In some examples, the dynamic clustering engine 114 may generate and/or merge clusters based on one or more distance metrics and/or thresholds. In some examples, the metrics and/or thresholds may be tuned based on characteristics of the one or more captures devices 102 and/or the audio environment.

In some examples, the dynamic clustering engine 114 may assign the source of interest to a particular cluster within the environment based on the updated audio source tracking data. In some examples, the dynamic clustering engine 114 may select the particular cluster as a previously determined cluster from a plurality of clusters for the environment. In some examples, the dynamic clustering engine 114 may remove a particular cluster from the plurality of clusters in response to the cluster being included in the plurality of clusters for a defined interval of time. For instance, a cluster may represent a location (e.g., an averaged location) of an active talker within an environment and the cluster may be updated with each new localization that is assigned to the cluster. Additionally, in response to a new location being calculated and assigned to the cluster, an oldest location from a set of locations associated with the cluster may be removed from the cluster. In some examples, in response to a new location being calculated and assigned to the cluster, an oldest location from a set of locations associated with the cluster may be additionally removed from one or more other clusters associated with the cluster. In some examples, historical locations for the cluster may be managed based on a buffer (e.g., a buffer/window of size N where N=150 last localizations). In some examples, a particular cluster may be removed from a plurality of clusters in response to a determination that there are no more locations assigned to the particular cluster (e.g., all locations have been removed from the particular cluster) such that the particular cluster no longer represents a source of interest within an environment.

Additionally, the dynamic clustering engine 114 may create a new cluster in response to receiving a localization data point that is not within a threshold distance of any existing cluster. The threshold distance may be a configurable parameter based on characteristics of the microphone array and/or the audio environment. In some examples, the dynamic clustering engine 114 may merge two or more clusters in response to determining that a particular cluster characteristics such as centroids of the two or more clusters are within a merge threshold distance of each other. Merging clusters may consolidate localization data points associated with a single source of interest that was previously represented by multiple clusters. In some examples, the dynamic clustering engine 114 may remove a cluster in response to determining that no new localization data points have been assigned to the cluster for a defined interval of time.

The temporal smoothing engine 116 may be utilized to fine-tune a location estimate for the source of interest. In some examples, the temporal smoothing engine 116 may utilize a mode filtering technique to reduce jitter and/or improve stability of a location estimate for the source of interest. For example, while elevation correction may address systematic errors and dynamic cluster smoothing may reduce variance in localization data points, challenges may persist for an active talker in the audio environment that is associated with multiple clusters, thereby causing a location for the source of interest to transition between two or more clusters. Thus, the temporal smoothing engine 116 may apply mode filtering subsequent to dynamic cluster smoothing to remove jitter from the location estimates.

Additionally, to mitigate jitter caused by transitions between multiple clusters over time, the temporal smoothing engine 116 may analyze the frequency of occurrence of different cluster assignments over a defined time window and select a most frequently occurring cluster as the output location. By applying mode filtering to cluster assignments, the temporal smoothing engine 116 may thereby reduce jitter and provide stable location estimates suitable for real-time camera control and beamforming applications.

In some examples, the temporal smoothing engine 116 may apply temporal smoothing to smoothed locations provided by the dynamic clustering engine 114. For instance, a cluster may utilize raw localizations that are repeatedly evaluated (e.g., continuously evaluated) in real time such that a cluster is generated for a source of interest (e.g., an active talkers). However, in a scenario for a microphone array with a smaller array size that may result in larger errors and/or variances in localization, multiple clusters may be generated for a single source of interest (e.g., a single active talker) in an environment. As such, different clusters may become activated for the source of interest over time as additional audio is provided by the source of interest. As such, the temporal smoothing engine 116 may apply temporal smoothing to a most-frequent cluster (over a period of time) for a source of interest, thereby providing smoothing of a partially smoothed location provided by the dynamic clustering engine 114.

In some examples, the temporal smoothing engine 116 may determine a frequency of occurrence of different location estimates over a defined interval of time for the source of interest. For example, the temporal smoothing engine 116 may utilize historical data for the source of interest for a particular historical interval of time to determine statistics regarding historical clusters for the source of interest. Additionally, based on the frequency of occurrence, the temporal smoothing engine 116 may determine a most frequently detected location for the source of interest.

In some examples, the temporal smoothing engine 116 may compare current audio localization data to historical audio localization data associated with the source of interest. The historical audio localization data may include previously determined location estimates for the source of interest over a defined historical interval of time. Based on the comparison, the temporal smoothing engine 116 may determine a predicted most frequent location for the source of interest. The predicted most frequent location may represent a location that is expected to be the most frequently occurring location for the source of interest based on analysis of the historical audio localization data. In some examples, the temporal smoothing engine 116 may generate updated audio source tracking data based on the predicted most frequent location for the source of interest.

In some examples, the temporal smoothing engine 116 may utilize a mode filter that stores and analyzes a plurality of clusters within a defined time window. The plurality of clusters may be determined by the dynamic clustering engine 114. The plurality of clusters may also be associated with different locations within the audio environment. In some examples, the temporal smoothing engine 116 may track the frequency of occurrence for different clusters of the plurality of clusters. In some examples, the temporal smoothing engine 116 may modify the audio source tracking data 118 based on the most frequently detected location for the source of interest. For instance, the temporal smoothing engine 116 may assign the source of interest to a different cluster of the plurality of clusters based on the most frequently detected location for the source of interest. In some examples, enhanced audio source tracking data provided by the temporal smoothing engine 116 may include a modified set of Cartesian coordinates or a modified set of spherical coordinates as compared to the audio source tracking data 118 provided by the dynamic clustering engine 114. Accordingly, the temporal smoothing engine 116 may mitigate fluctuations in location estimates for the source of interest, thereby enabling more accurate tracking of the source of interest, even in challenging acoustic environments for a microphone array where precise elevation estimation remains difficult.

The audio source tracking system 104 may output the audio source tracking data 118 to an output device communicatively coupled to the one or more capture devices 102. For example, audio source tracking system 104 may output the audio source tracking data 118 to an output device communicatively coupled to the microphone array that captures the audio stream 106. The audio source tracking data 118 may represent processed and/or refined location data for the source of interest within the audio environment. For example, the audio source tracking data 118 may indicate a tracked location of the source of interest within the audio environment. The audio source tracking data 118 may include a set of coordinates with respect to the microphone array. For example, the audio source tracking data 118 may include Cartesian coordinates (e.g., X, Y, and Z coordinates) and/or spherical coordinates (e.g., radial distance, Azimuth angle, and elevation angle) that identify the source of interest within the audio environment. The Cartesian coordinates and/or the spherical coordinates may represent a location of the source of interest in real time with respect to capture of the audio stream 106. For example, in the context of audio source localization and tracking, the Cartesian coordinates and/or the spherical coordinates may be utilized to describe the position of source of interest relative to the microphone array. The Cartesian coordinates may represent points in space using a set of numerical coordinates that measure the distance of the point from perpendicular reference axes. The spherical coordinates may provide a three-dimensional representation of a location in space relative to a fixed origin.

The output device may include one or more of: a speaker, a speaker array, headphones, earphones, a video capture device (e.g., a camera), a codec (e.g., coder-decoder) device, an audio mixer device, a smartphone, a tablet computer, a laptop, a personal computer, an audio workstation device, a wearable device, an augmented reality device, a virtual reality device, a broadcasting device, a recording device, a haptic device, an Internet of Things (IoT) device, an automation system device, or another type of output device. In some examples, the audio source tracking system 104 may output the audio source tracking data 118 to a camera device. For example, the audio source tracking system 104 may transmit the audio source tracking data 118 to a camera control system of the camera device to enable control of the camera device based on the audio source tracking data 118. In some examples, the audio source tracking system 104 may enable control of the camera device to modify camera framing based on the audio source tracking data 118.

The camera control system may be a hardware component, a software module, or a combination of hardware and software configured to control one or more operational parameters of a camera device. In some examples, the camera control system may receive the audio source tracking data 118 and utilize the audio source tracking data 118 to control pan, tilt, zoom, focus, and/or one or more other operational parameters of the camera device. The camera control system may be integrated within the camera device or may be a separate component communicatively coupled to the camera device. In some examples, the camera control system may include a processor configured to process the audio source tracking data 118 and generate control signals for actuators, motors, and/or one or more other mechanical components of the camera device to adjust a position and/or orientation of the camera device.

Camera framing may refer to a composition of visual content captured by a camera device. For instance, camera faming may comprise a position, size, and/or arrangement of subjects within a captured image or video frame. Modification of camera framing may include adjusting one or more parameters of the camera device to alter how a source of interest appears within the captured visual content. In some examples, modification of camera framing may include adjusting a pan angle, a tilt angle, a zoom level, and/or a crop region of the camera device to center or otherwise position the source of interest within the captured visual content. In some examples, modification of camera framing may be performed automatically by the camera control system based on the audio source tracking data 118 to maintain the source of interest within a desired region of the captured visual content as the source of interest moves within the audio environment.

In some examples, the output device may utilize the audio source tracking data 118 for one or more audio processing applications such as, but not limited to: beamforming and/or spatial filtering to enhance audio capture from specific directions, acoustic echo cancellation with improved source localization, noise reduction by focusing beamforming on desired audio sources, automatic camera steering in a video conferencing system for improved audio capture for video data, spatial audio rendering for immersive sound reproduction, sound source separation for complex acoustic scenes, adaptive gain control based on source distance and direction, room acoustics analysis and environmental mapping, and/or one or more other types of audio processing applications. In some examples, the audio source tracking data 118 may be utilized to generate audio output data. The audio output data may include: an audio stream, a video stream, broadcast audio, broadcast video, speech reinforcement audio, and/or other audio output data. In some examples, the audio output data may be an enhanced version of the audio stream 106 to enable desirable and/or appropriately processed audio for the audio environment. In some examples, the audio output data includes beamformed audio data that is digitally processed to enhance audio of the audio stream 106. In some examples, the output device may perform audio processing based on the audio source tracking data 118 to amplify, equalize, filter, and/or otherwise enhance the audio stream 106. In some examples, the output device may perform denoising, dereverberation, speech shaping, artifacts reduction, acoustic echo cancellation (AEC), and/or other audio processing with respect to the audio stream 106.

In some examples, the output device may additionally or alternatively utilize the audio source tracking data 118 for one or more video processing applications such as, but not limited to: individual framing for video conferencing, generating input data (e.g., a cropped face) for an AI model, providing audio source separation for video data, selecting an optimal video capture device in an audio environment, automatic camera framing to focus on active speakers, dynamic adjustment of camera zoom levels based on speaker distance, intelligent switching between multiple cameras to capture different participants, facial recognition and tracking of speakers, gesture recognition for non-verbal communication cues, augmented reality overlays positioned relative to speaker locations, automatic generation of speaker name tags or labels in video feeds, optimization of video encoding parameters based on areas of interest, creation of virtual camera views for improved meeting layouts, automatic adjustment of lighting or exposure settings to enhance visibility of active speakers, generation of speaker-focused picture-in-picture views, spatial audio rendering aligned with video positioning, real-time video composition for optimal display of multiple participants in large group settings, creating a 3D model of an audio environment, and/or one or more other types of video processing applications.

In some examples, the audio source tracking data 118 may be included in control data (e.g., one or more control signals) for the output device to configure and/or control the output device. For example, the control data that includes the audio source tracking data 118 may be utilized to control and/or configure one or more portions of the output device. In some examples, the control data may include one or more configuration parameters (e.g., a configuration parameter set) configured based on the audio source tracking data 118. In some examples, the one or more configuration parameters include a configuration parameter such as, but not limited to one or more: a camera setting, camera selection, camera focus direction, pan, zoom, crop, microphone array settings, a beam steering setting, a video encoding setting, a video frame transmission setting, video frame size, frame rate, color depth settings, resolution format settings, and/or another type of configuration parameter for the output device.

In some examples, output device may modify video framing of the output device based on the audio source tracking data 118. Modification of the video framing may alter a position of visual data associated with a source of interest in one or more video frames. In some examples, the output device may utilize the control data to modify the video framing. In some examples, the output device may utilize the control data to steer a microphone array beam for the one or more capture devices 102. For instance, beam steering associated with the one or more capture devices 102 may be performed based on the audio source tracking data 118. In some examples, a microphone array may be configured to steer respective beamforming lobes of a plurality of beamforming lobes toward a desired location and/or angle within an environment based on the audio source tracking data 118. In some examples, the audio source tracking data 118 may be utilized to determine a direction for steering one or more beamformed lobes for one or more capture devices to improve signal-to-noise ratio for audio signals.

In some examples, the beamforming circuitry 210 may receive the audio source tracking data 118 and calculate beamforming weights for the microphone array based on the tracked location of the source of interest. The beamforming weights may be applied to audio signals from individual microphones of the microphone array to constructively combine audio arriving from the direction of the source of interest while attenuating audio arriving from other directions. By utilizing the audio source tracking data 118 to dynamically update beamforming weights, the beamforming circuitry 210 may provide improved audio capture for a moving source of interest.

In some examples, a shape of a beamforming lobe may be modified based on the audio source tracking data 118. For example, the audio source tracking data 118 may provide information regarding a spatial distribution associated with a source of interest to enable a beamforming lobe to be adaptively reshaped for improved audio capture for the source of interest while suppressing unwanted noise. Reshaping of a beamforming lobe may include adjusting beamforming lobe parameters such as width, direction, and/or side lobe suppression of a beamforming pattern to optimize a signal-to-noise ratio for the beamforming lobe. A shape of a beamforming lobe may be a rounded shape to provide a wider beam for capturing audio, an elongated shape to provide a more directed beam for capturing audio, or another type of shape to optimally capture audio associated with a source of interest.

In some examples, the control data may enable or disable one or more functionalities associated with the output device. For instance, the control data may include one or more control signals and/or configuration data to enable or disable one or more video processing tasks. A video processing task may include camera data acquisition, video encoding/decoding, video machine learning modeling, or another type of video processing task. In some examples, the control data may be additionally or alternatively utilized to: initiate feature extraction with respect to video data, configure parameters or types of features to be extracted, etc.

Accordingly, the audio source tracking system 104 may provide improved audio source tracking for the audio stream 106 as compared to traditional beamforming techniques. For example, the audio source tracking system 104 may provide intelligent audio source tracking associated with the audio stream 106, thereby enabling optimal audio capture of audio for a source of interest in the audio environment. The audio source tracking system 104 may additionally or alternatively be adapted to produce improved audio signals with reduced noise and/or other undesirable audio artifacts even in view of audio latency requirements for real time audio processing and/or video processing associated with an audio environment. For example, the audio source tracking system 104 may generate the audio source tracking data 118 while maintaining audio latency requirements for providing audio for one or more other audio source locations and/or a real-time video stream associated with the audio environment. As such, an audio stream may be provided to an output device with improved audio quality. The audio source tracking system 104 may also improve runtime efficiency of audio source tracking, audio filtering, denoising, and/or other audio processing while also optimizing beamforming of audio for an audio environment.

In some examples, the audio source tracking system 104 may be implemented across a plurality of microphone arrays positioned within an audio environment. For instance, the plurality of microphone arrays positioned within the audio environment may be respectively configured to perform enhanced audio source tracking operations including acoustic localization, elevation correction, dynamic clustering, and/or temporal smoothing as disclosed herein. Each microphone array of the plurality of microphone arrays may also generate respective audio source tracking data for a source of interest within the audio environment.

The plurality of microphone arrays may also be communicatively coupled via a network. The network may be a wired network, a wireless network, a local area network, or another type of network that enables communication between the plurality of microphone arrays. Additionally, each microphone array of the plurality of microphone arrays may transmit enhanced audio source tracking data and/or associated timing information to a network channel accessible by other devices within the audio environment.

In some examples, a microphone array of the plurality of microphone arrays may be designated as a reporter device that collects and combines enhanced audio source tracking data from one or more other microphone arrays of the plurality of microphone arrays. Alternatively, an external aggregator device communicatively coupled to the plurality of microphone arrays via the network may collect and combine the enhanced audio source tracking data. The reporter device or the external aggregator device may process the combined enhanced audio source tracking data from the plurality of microphone arrays to calculate and produce a position estimate with improved precision for a source of interest within the audio environment. By combining position information from multiple spatially distributed microphone arrays, the reporter device or the external aggregator device may also improve accuracy and reliability of audio source tracking as compared to a single microphone array operating independently.

In some examples, the position estimate generated by the reporter device or the external aggregator device may be output to an output device such as a camera device to enable enhanced camera tracking interoperability. The higher-precision position estimate may also enable improved camera framing, more accurate automatic camera steering, and/or more reliable tracking of active speakers within the audio environment.

The audio source tracking system 104 may also employ fewer of computing resources when compared to traditional audio processing systems that are used for audio source tracking. Additionally or alternatively, in some examples, the audio source tracking system 104 may be configured to deploy a smaller number of memory resources allocated to audio source tracking, beamforming, and/or other audio filtering for an audio stream sample such as, for example, the audio stream 106. In some examples, the audio source tracking system 104 may be configured to improve processing speed of audio source tracking operations, beamforming operations, and/or audio filtering operations. These improvements may enable an improved audio processing systems to be deployed in microphones, audio conferencing processors, and/or or other hardware/software configurations where processing and memory resources are limited, and/or where processing speed and efficiency is important for functionality of an audio system.

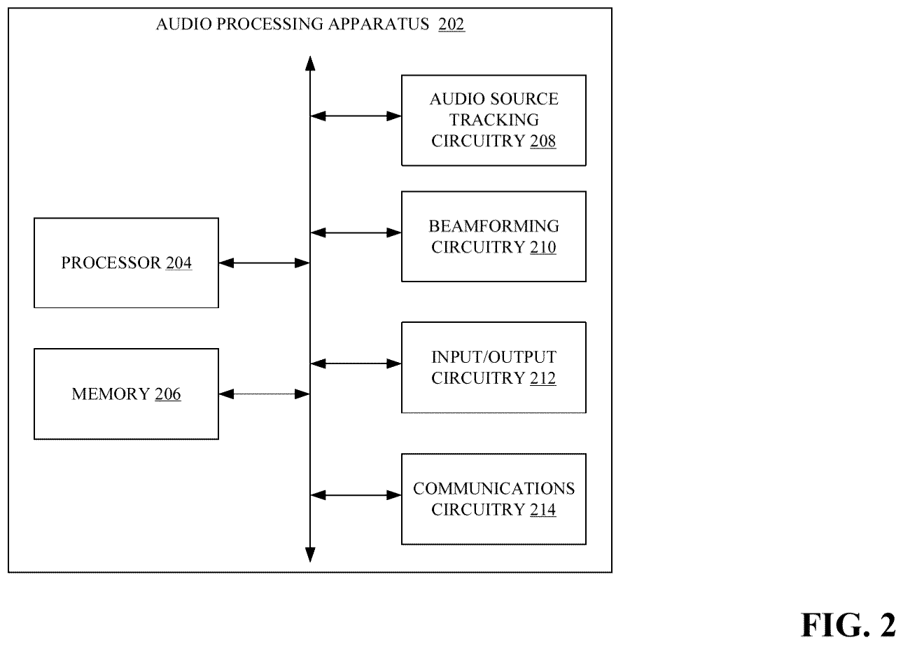

FIG. 2 illustrates an example beamforming audio processing apparatus 202 configured in accordance with one or more embodiments of the present disclosure. The beamforming audio processing apparatus 202 may be configured to perform one or more techniques described in FIG. 1 and/or one or more other techniques described herein.

The beamforming audio processing apparatus 202 may be a computing system communicatively coupled with one or more circuit modules related to audio processing. The beamforming audio processing apparatus 202 may comprise or otherwise be in communication with a processor 204, a memory 206, audio source tracking circuitry 208, beamforming circuitry 210, input/output circuitry 212, and/or communications circuitry 214. In some examples, the processor 204 (which may comprise multiple or co-processors or any other processing circuitry associated with the processor) may be in communication with the memory 206.

The memory 206 may comprise non-transitory memory circuitry and may comprise one or more volatile and/or non-volatile memories. In some examples, the memory 206 may be an electronic storage device (e.g., a computer readable storage medium) configured to store data that may be retrievable by the processor 204. In some examples, the data stored in the memory 206 may comprise audio data, stereo audio signal data, mono audio signal data, radio frequency signal data, SRP transformation data, a set of SRP weights, or the like, for enabling the beamforming audio processing apparatus 202 to carry out various functions or methods in accordance with embodiments of the present disclosure, described herein.

In some examples, the processor 204 may be embodied in a number of different ways. For example, the processor 204 may be embodied as one or more of various hardware processing means such as a central processing unit (CPU), a microprocessor, a coprocessor, a DSP, a field programmable gate array (FPGA), a neural processing unit (NPU), a graphics processing unit (GPU), a system on chip (SoC), a cloud server processing element, a controller, or a processing element with or without an accompanying DSP. The processor 204 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some examples, the processor 204 may comprise one or more processing cores configured to perform independently. A multi-core processor may enable multiprocessing within a single physical package. Additionally or alternatively, the processor 204 may comprise one or more processors configured in tandem via a bus to enable independent execution of instructions, pipelining, and/or multithreading. In some examples, the processor 204 may be an audio conferencing processor.

In some examples, the processor 204 may be configured to execute instructions, such as computer program code or instructions, stored in the memory 206 or otherwise accessible to the processor 204. Alternatively or additionally, the processor 204 may be configured to execute hard-coded functionality. As such, whether configured by hardware or software instructions, or by a combination thereof, the processor 204 may represent a computing entity (e.g., physically embodied in circuitry) configured to perform operations according to an example of the present disclosure described herein. For example, when the processor 204 is embodied as an CPU, DSP, ARM, FPGA, ASIC, or similar, the processor may be configured as hardware for conducting the operations of an example of the disclosure. Alternatively, when the processor 204 is embodied to execute software or computer program instructions, the instructions may specifically configure the processor 204 to perform the algorithms and/or operations described herein when the instructions are executed. However, in some examples, the processor 204 may be a processor of a device specifically configured to employ an example of the present disclosure by further configuration of the processor using instructions for performing the algorithms and/or operations described herein. The processor 204 may further comprise a clock, an arithmetic logic unit (ALU) and logic gates configured to support operation of the processor 204, among other things.

In one or more examples, the beamforming audio processing apparatus 202 may comprise the audio source tracking circuitry 208. The audio source tracking circuitry 208 may be any means embodied in either hardware or a combination of hardware and software that is configured to perform one or more functions disclosed herein related to the acoustic localization engine 110, the elevation correction engine 112, the dynamic clustering engine 114, and/or the temporal smoothing engine 116. In one or more examples, the beamforming audio processing apparatus 202 may comprise the beamforming circuitry 210. The beamforming circuitry 210 may be any means embodied in either hardware or a combination of hardware and software that is configured to perform one or more functions disclosed herein related to beamforming for a microphone array based on audio source tracking data (e.g., the audio source tracking data 118) provided by the audio source tracking system 104.

In some examples, the beamforming audio processing apparatus 202 may comprise the input/output circuitry 212 that may, in turn, be in communication with processor 204 to provide output to the user and, in some examples, to receive an indication of a user input. The input/output circuitry 212 may comprise a user interface and may comprise a display. In some examples, the input/output circuitry 212 may also comprise a keyboard, a touch screen, touch areas, soft keys, buttons, knobs, or other input/output mechanisms.

In some examples, the beamforming audio processing apparatus 202 may comprise the communications circuitry 214. The communications circuitry 214 may be any means embodied in either hardware or a combination of hardware and software that is configured to receive and/or transmit data from/to a network and/or any other device or module in communication with the beamforming audio processing apparatus 202. In this regard, the communications circuitry 214 may comprise, for example, an antennae or one or more other communication devices for enabling communications with a wired or wireless communication network. For example, the communications circuitry 214 may comprise antennae, one or more network interface cards, buses, switches, routers, modems, and supporting hardware and/or software, or any other device suitable for enabling communications via a network. Additionally or alternatively, the communications circuitry 214 may comprise the circuitry for interacting with the antenna/antennae to cause transmission of signals via the antenna/antennae or to handle receipt of signals received via the antenna/antennae.

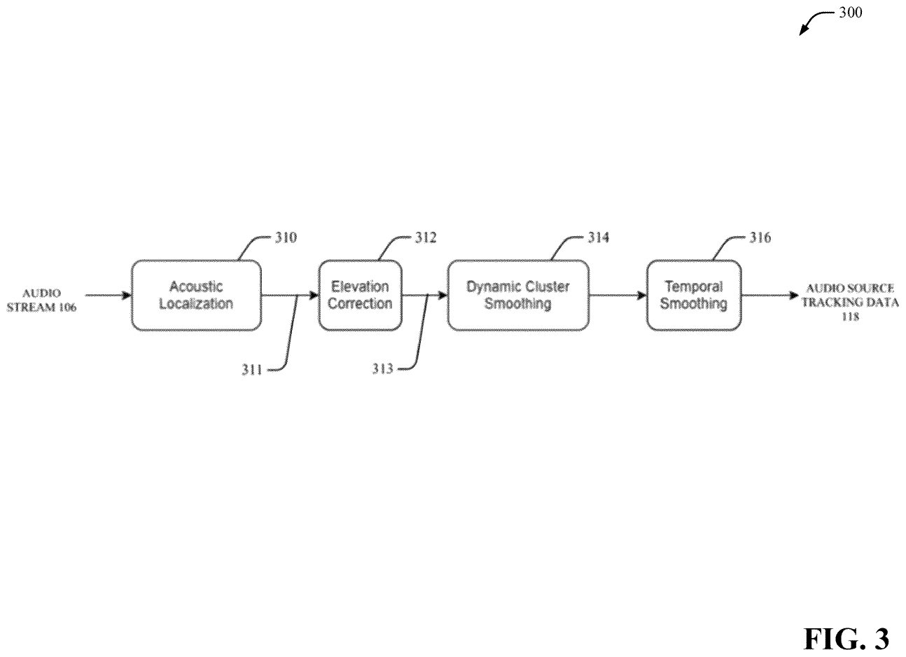

FIG. 3 illustrates an audio processing pipeline 300 associated with enhanced audio source tracking enabled by the audio source tracking system 104 of FIG. 1 according to one or more embodiments of the present disclosure. For example, the audio processing pipeline 300 may be a multi-stage audio processing pipeline that includes acoustic localization 310 associated with the acoustic localization engine 110, elevation angle correction associated with the elevation correction engine 112, dynamic cluster smoothing associated with dynamic clustering engine 114, and/or temporal smoothing associated with the temporal smoothing engine 116 to enable enhanced audio source tracking.

The acoustic localization 310 may be a first stage of the audio processing pipeline 300 that processes the audio stream 106 to determine audio localization data 311 associated with the audio stream 106. The audio localization data 311 may be provided as input to the elevation correction 312 (e.g., a second stage of the audio processing pipeline 300) to adjust elevation angle data associated with the audio localization data 311. By adjusting the elevation angle data associated with the audio localization data 311, the elevation correction 312 may provide tuned audio localization data 313. In some example, the tuned audio localization data 313 may be provided as input to the dynamic cluster smoothing 314 (e.g., a fourth stage of the audio processing pipeline 300) to perform one or more clustering operations on the tuned audio localization data 313. The final stage of the audio processing pipeline 300 may correspond to the temporal smoothing 316 to further refine the tuned audio localization data 313. In some embodiments, the audio source tracking data 118 for the source of interest may be determined based on the tuned audio localization data 313 associated with the elevation correction 312, the dynamic cluster smoothing 314, and/or the temporal smoothing 316.

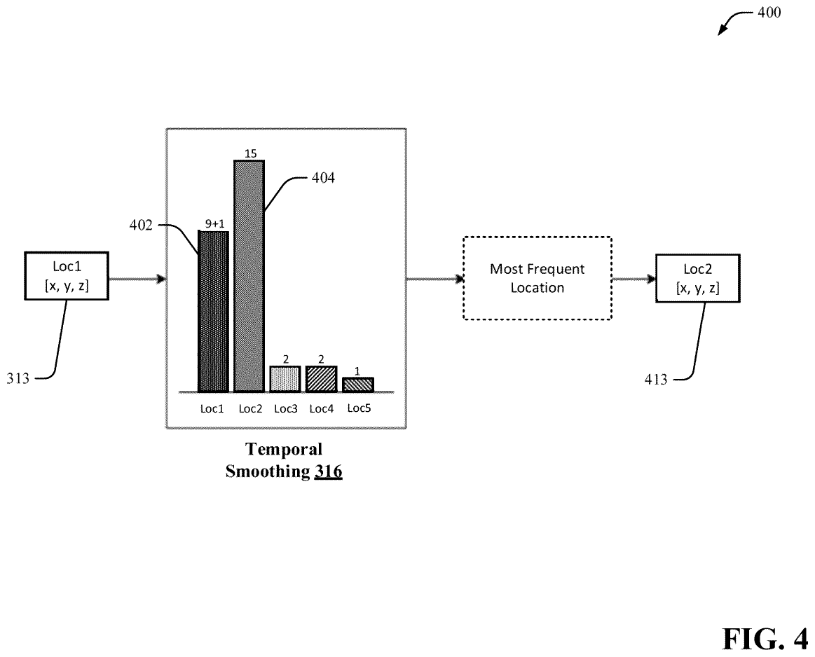

FIG. 4 illustrates a temporal smoothing pipeline 400 associated with temporal smoothing enabled by the audio source tracking system 104 of FIG. 1 according to one or more embodiments of the present disclosure. For example, the temporal smoothing pipeline 400 may be associated with the temporal smoothing 316. In some examples, the temporal smoothing 316 may utilize mode filtering to reduce jitter in the tuned audio localization data 313. In some examples, the mode filtering may be applied to the tuned audio localization data 313 after the dynamic cluster smoothing 314.

As illustrated in FIG. 4, the dynamic cluster smoothing 314 may utilize clustering associated with a plurality of clusters that includes at least a cluster 402 and a cluster 404. In some examples, the dynamic cluster smoothing 314 may assign the tuned audio localization data 313 to the cluster 402 and the temporal smoothing 316 may reassign the tuned audio localization data 313 to the cluster 404 to provide tuned audio localization data 413. In some examples, the tuned audio localization data 413 may include a modified set of Cartesian coordinates or a modified set of spherical coordinates as compared to the tuned audio localization data 313.

The temporal smoothing 316 may utilize statistical information associated with different location estimates to further refine the tuned audio localization data 313. In an example, the temporal smoothing 316 may utilize mode information (e.g., frequency of occurrence) of different location estimates to further refine the tuned audio localization data 313. In some examples, the temporal smoothing 316 may utilize a mode filter that stores and analyzes a given number of clusters (e.g., five clusters, etc.) within a given time window (e.g., a 2-second time window, etc.). However, it is to be appreciated that the temporal smoothing 316 may utilize a mode filter that stores and analyzes any number of clusters and/or any number of time windows. The temporal smoothing 316 may track the frequency of occurrence for different locations (e.g., Loc1 through Loc5). For example, the cluster 402 may be associated with Loc1, cluster 404 may be associated with Loc2, etc. In some examples, the temporal smoothing 316 may maintain a record of the start time for each added location point in the plurality of clusters. As new location data is received, the temporal smoothing 316 may automatically remove an expired cluster that falls outside the 2-second window to allow recent data to influence the temporal smoothing process.

In some examples, the mode filter may maintain a sliding window buffer that stores cluster assignments for the source of interest over the defined time window. Each entry in the sliding window buffer may include a cluster identifier and/or a timestamp indicating when the cluster assignment was made. As new cluster assignments are received from the dynamic clustering engine 114, the mode filter may add the new cluster assignment to the sliding window buffer and remove any entries with timestamps older than the defined time window. The mode filter may then count the frequency of occurrence for each unique cluster identifier in the sliding window buffer and select the cluster identifier with the highest frequency as the output location for the source of interest. In a scenario where two or more cluster identifiers comprise an equal frequency of occurrence, the mode filter may select the cluster identifier associated with the most recent cluster assignment.

In some examples, the temporal smoothing 316 may receive location coordinates (x, y, z) associated with the tuned audio localization data 313 as input. The temporal smoothing 316 may process the tuned audio localization data 313 using frequency analysis to determine how often each location occurs within the specified time window. Based on the frequency analysis, the temporal smoothing 316 may select a most frequent location (e.g., a predicted most frequent location) such as Loc2 associated with the tuned audio localization data 413. As shown in FIG. 4, this may result in a second location (Loc2) with corresponding coordinates (x, y, z). By selecting the most frequent location, the temporal smoothing 316 may effectively reduce jitter and transient fluctuations in the tuned audio localization data 313 thereby enabling more accurate location information for the source of interest.

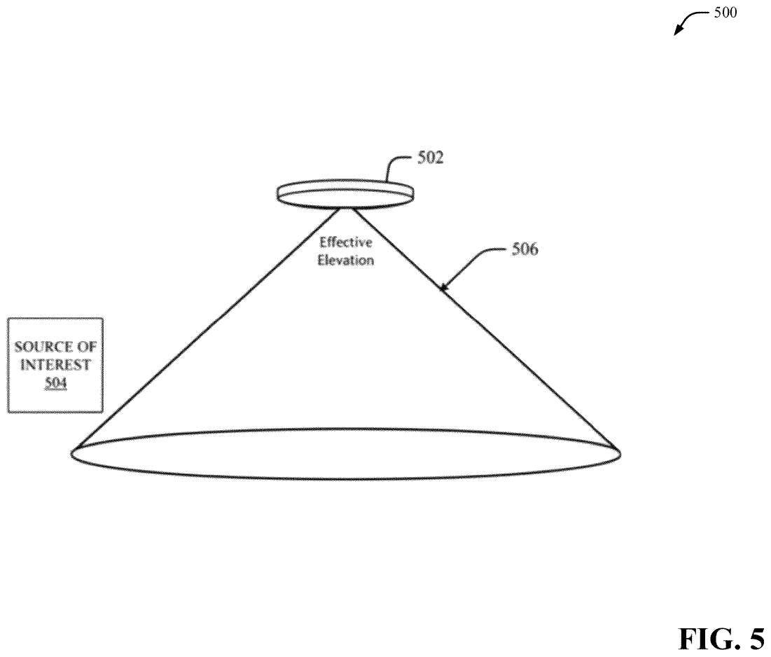

FIG. 5 illustrates an audio environment 500 associated with enhanced audio source tracking enabled by the audio source tracking system 104 of FIG. 1 according to one or more embodiments of the present disclosure. The audio environment 500 includes a microphone array 502 and a source of interest 504. The source of interest 504 may be an audio source, a sound source, a speaker, or another type of source of interest within the audio environment 500. Additionally, the microphone array 502 may be associated with an effective coverage 506. The effective coverage 506 may be a spatial region within which the microphone array 502 may reliably detect, localize, and/or capture audio from the source of interest 504 with desirable quality. Additionally, the effective coverage 506 may be defined by one or more boundaries associated with elevation angle, azimuth angle, and/or distance from the microphone array 502. However, the effective coverage 506 may be influenced by several factors such as a geometry and/or size of the microphone array 502. In some examples, the source of interest 504 may be located outside the effective coverage 506 of the microphone array 502.

In some examples, the effective coverage 506 may be bounded by a minimum elevation angle below which localization accuracy degrades by an undesirable amount. For a ceiling-mounted microphone array, the minimum elevation angle may correspond to sources of interest positioned at the periphery of a room or at locations distant from directly beneath the microphone array 502. In some examples, the effective coverage 506 may also be bounded by a maximum distance from the microphone array 502 beyond which signal-to-noise ratio decreases below a threshold suitable for reliable localization. The size of the microphone array 502 may directly influence the extent of the effective coverage 506, with larger microphone arrays generally providing wider effective coverage than smaller microphone arrays. When the source of interest 504 is located outside the effective coverage 506, the audio localization data generated by the acoustic localization engine 110 may exhibit increased error, which the elevation correction engine 112 may compensate for via the defined elevation angle correction. As such, the audio source tracking system 104 may be utilized to provide enhanced detection, localization, and/or capture of audio from the source of interest 504 by utilizing the acoustic localization, elevation correction, dynamic clustering, and/or temporal smoothing further disclosed herein.

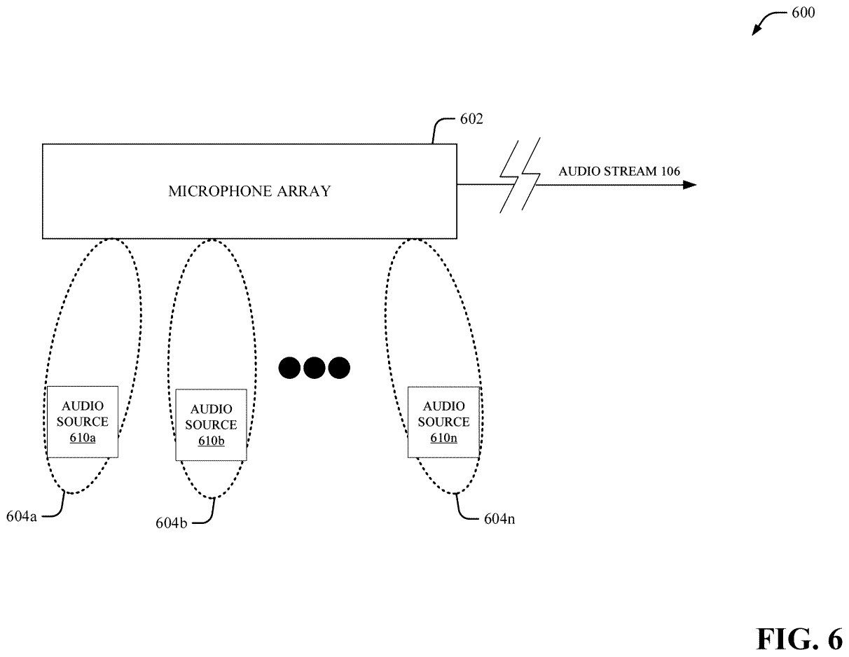

FIG. 6 illustrates a system 600 associated with a microphone array that provides the audio stream 106 processed by the audio source tracking system 104 of FIG. 1 according to one or more embodiments of the present disclosure. The system 600 includes a microphone array 602 associated with a plurality of beamforming lobes 604a-n. In some examples, the microphone array 602 corresponds to the one or more capture devices 102. In some examples, respective beamforming lobes of the plurality of beamforming lobes 604a-n may capture audio associated with one or more audio sources 610a-n. In some examples, respective beamforming lobes of the plurality of beamforming lobes 604a-n may be positioned to capture audio from a respective audio source of the one or more audio sources 610a-n. The microphone array 602 may be a linear microphone array, a planar microphone array, a circular microphone array, a 2D microphone array, a 3D surface microphone array, a suspended 3D microphone array, a ceiling microphone array, or another type of microphone array. Additionally, a shape of respective beamforming lobes of the plurality of beamforming lobes 604a-n may be a rounded shape to provide a wider beam for capturing audio, an elongated shape to provide a more directed beam for capturing audio, or another type of shape to optimally capture audio associated with one or more audio sources.

The microphone array 602 may convert the audio captured by the plurality of beamforming lobes 604a-n into the audio stream 106 provided as input to the audio source tracking system 104. For instance, the microphone array 602 may include a plurality of transducers configured to utilize signal processing techniques to uniformly capture and process sound wave data associated with the one or more audio sources 610a-n. In some examples, the plurality of transducers may be a plurality of micro-electrical mechanical system (MEMS) transducers. In some examples, the microphone array 602 may utilize one or more beamforming techniques to produce the plurality of beamforming lobes 604a-n. In some examples, the plurality of beamforming lobes 604a-n may be a plurality of steerable beamforming lobes. For example, the microphone array 602 may be configured to steer respective beamforming lobes of the plurality of beamforming lobes 604a-n toward a desired location and/or angle within an audio environment.

In some examples, the microphone array 602 may be a sound wave capture device (e.g., a 1.5D microphone array, a 2D linear and planar microphone array, a 3D surface arrays of microphones, and 3D suspended arrays of microphones) associated with omnidirectional and unidirectional audio capture devices. For example, a 1.5D microphone array may be a microphone array configured to provide a one-dimensional form factor that has added directivity, for most, if not all, frequencies, in dimensions that, conventionally, have equal sensitivity in all directions.

The microphone array 602 may be configured to combine audio associated with respective beamforming lobes of the plurality of beamforming lobes 604a-n to generate the audio stream 106. In some examples, the audio stream may be configured based on a directional polar pattern associated with respective beamforming lobes of the plurality of beamforming lobes 604a-n. In some examples, audio from an audio source may be out of direct beamforming coverage of a particular beamforming lobe of the microphone array 602. For instance, a beamforming lobe 604a and/or another beamforming lobe (e.g., beamforming lobe 604b or beamforming lobe 604n) may be unable to adequately capture audio associated with an audio source 610a or another audio source outside an effective coverage of the beamforming lobe 604a. As such, the audio source tracking system 104 may apply acoustic localization, elevation correction, dynamic clustering, and/or temporal smoothing to the audio stream 106 as further disclosed herein to enable enhanced audio source tracking for the audio source 610a or another audio source. The audio source tracking system 104 may further enable improved audio quality and intelligibility for audio output. By applying sophisticated signal processing techniques to enable enhanced audio source tracking, the audio source tracking system 104 further ensures that active audio sources are clearly captured and reproduced, even when portions of the audio source are outside an effective coverage area of the microphone array 602.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

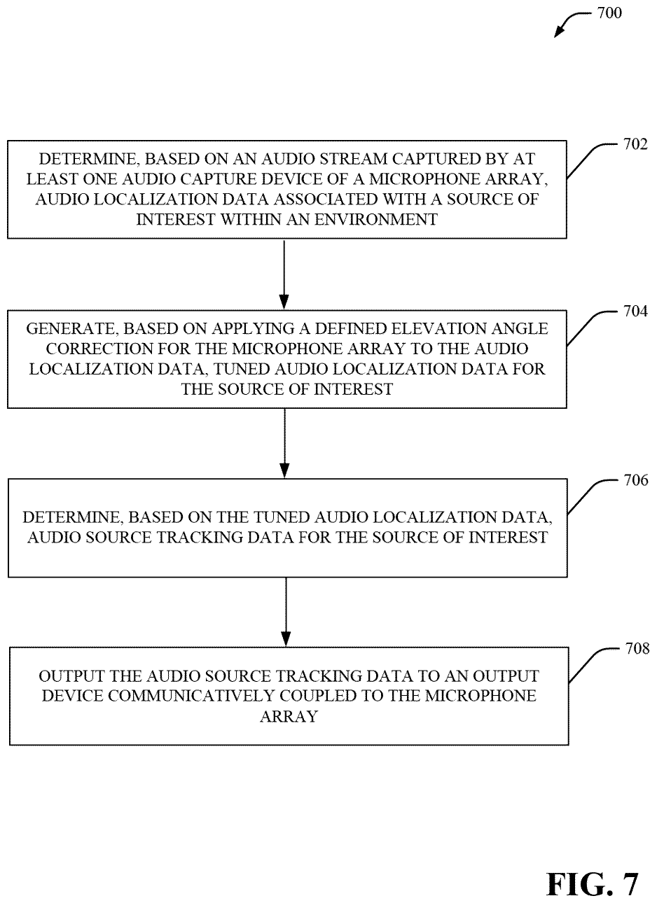

FIG. 7 is a flowchart diagram of an example process 700, for providing enhanced audio source tracking in accordance with, for example, the beamforming audio processing apparatus 202 illustrated in FIG. 2. Via the various operations of the process 700, the beamforming audio processing apparatus 202 may enhance quality and/or of beamformed audio data.

At block 702 a processor (e.g., the processor 204 and/or the audio source tracking circuitry 208) determines audio localization data associated with a source of interest within an environment based on an audio stream captured by at least one audio capture device of a microphone array.

At block 704 a processor (e.g., the processor 204 and/or the audio source tracking circuitry 208) generates tuned audio localization data for the source of interest based on applying a defined elevation angle correction for the microphone array to the audio localization data. The audio localization data may comprise time difference of arrival information. The defined elevation angle correction may comprise a defined value for the microphone array that compensates for potential error in an elevation angle estimation associated with the audio localization data. In some examples, the defined elevation angle correction is based on a predetermined relationship between original elevation angles and corrected elevation angles for the microphone array.

At block 706 a processor (e.g., the processor 204 and/or the audio source tracking circuitry 208) determines audio source tracking data for the source of interest based on the tuned audio localization data. The audio source tracking data may comprise a set of coordinates with respect to the microphone array. In some examples, the set of coordinates comprises Cartesian coordinates or spherical coordinates that identify the source of interest within the environment in real time.

At block 708 a processor (e.g., the processor 204 and/or the audio source tracking circuitry 208) outputs the audio source tracking data to an output device communicatively coupled to the microphone array. The output device may be a camera device. In some examples, the audio source tracking data may be transmitted to a camera control system of the camera device to enable control of the camera device based on the audio source tracking data. The control of the camera device may enable modification of camera framing based on the audio source tracking data.

In some examples, temporal smoothing may be applied to the audio source tracking data to generate updated audio source tracking data for the source of interest. To determine a predicted most frequent location for the source of interest, the audio localization data may be compared to historical audio localization data associated with the source of interest. Additionally, the updated audio source tracking data may be generated based on the predicted most frequent location for the source of interest.

In some examples, the source of interest may be assigned to a particular cluster within the environment based on the tuned audio localization data. The particular cluster may be a previously determined cluster selected from a plurality of clusters for the environment. The particular cluster may comprise a group of data points associated with a region within the audio environment. In some examples, the particular cluster may be removed from the plurality of clusters in response to the particular cluster being included in the plurality of clusters for a defined interval of time.

Although the process 700 depicts a particular sequence of operations, the sequence may be altered without departing from the scope of the present disclosure. For example, some of the operations depicted may be performed in parallel or in a different sequence that does not materially affect the function of the processes. Additionally, such operations may be performed in any of a number of ways, including, without limitation, in the order and manner as depicted and described herein. In some examples, the process 700 includes some or all operations described and/or depicted. Similarly, it should be appreciated that one or more of the operations of the process 700 may be combinable, replaceable, and/or otherwise altered as described herein.

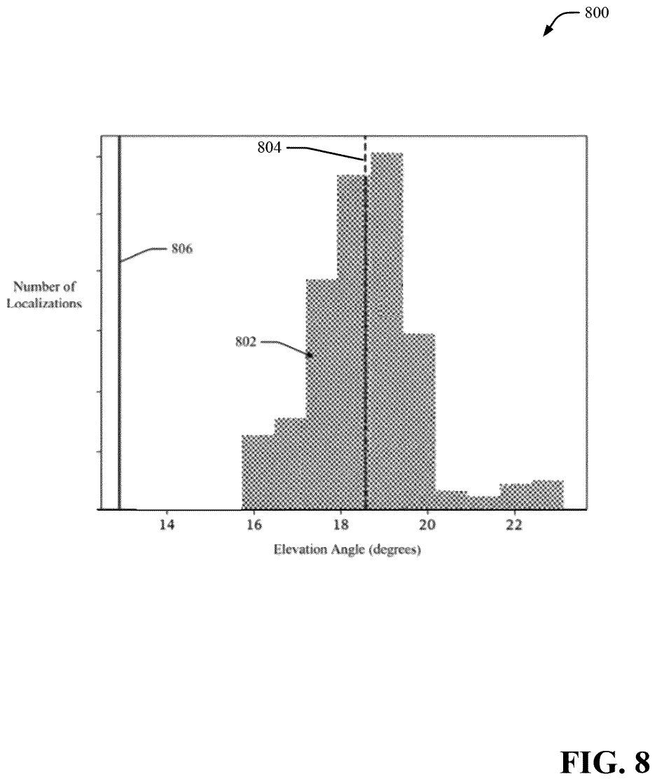

FIG. 8 illustrates a graph 800 associated with localizations for a microphone array according to one or more embodiments of the present disclosure. For example, the graph 800 includes a distribution 802 of localizations for a microphone array. The distribution 802 of localizations may represent localizations points calculated for the microphone array over a certain interval of time for a source of interest. As illustrated in FIG. 8, a size and/or shape of the microphone array may affect accuracy of the localizations such that an average elevation angle 804 calculated for the distribution 802 of localizations differs from an actual elevation angle 806 for the distribution 802 of localizations. As such, it is desirable to apply a defined elevation angle correction for the localizations to fix potential error associated with the localizations. In some examples, a difference between the average elevation angle 804 and the actual elevation angle 806 illustrated in FIG. 8 represents a systematic bias in elevation angle estimation that the elevation correction engine 112 is configured to correct, as more fully disclosed here.

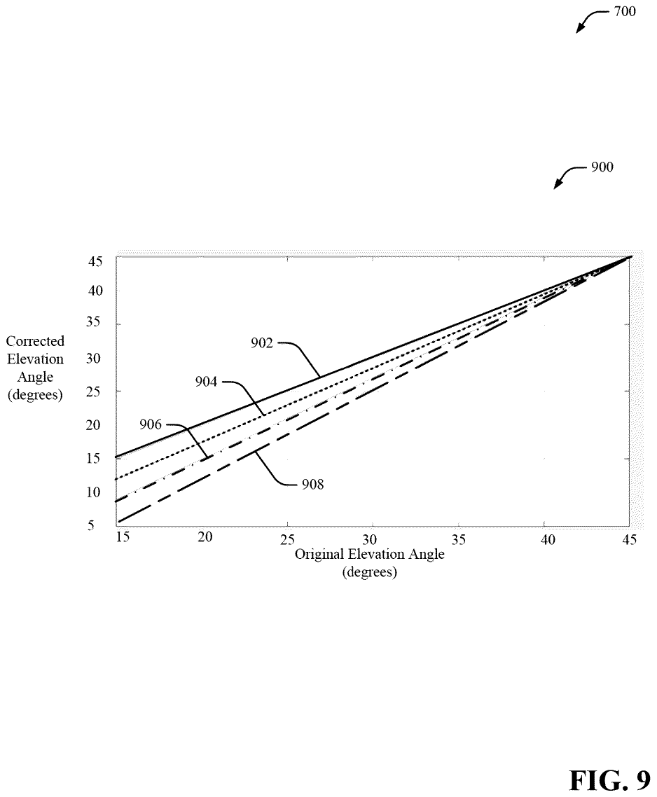

FIG. 9 illustrates a graph 900 associated with correcting an elevation angle for a localization calculated for a microphone array according to one or more embodiments of the present disclosure. For example, the graph 900 includes an original elevation angle 902 calculated for a microphone array. Additionally, the graph 900 includes a first level of elevation angle correction 904 with respect to the original elevation angle 902, a second level of elevation angle correction 906 with respect to the original elevation angle 902, and a third level of elevation angle correction 908 with respect to the original elevation angle 902. For example, the audio source tracking system 104 may utilize a first defined elevation angle correction to provide the first level of elevation angle correction 904, a second defined elevation angle correction to provide the second level of elevation angle correction 906 with respect to the original elevation angle 902, or a third defined elevation angle correction to provide the third level of elevation angle correction 908 with respect to the original elevation angle 902. Accordingly, the audio source tracking system 104 may compensate for potential inaccuracies in the original elevation angle 902 via elevation angle correction.

It is to be appreciated that a defined elevation angle correction may be applied differently depending on the original elevation angle. For instance, the first level of elevation angle correction 904, the second level of elevation angle correction 906, and the third level of elevation angle correction 908 may correspond to different values of the defined elevation angle correction C for different microphone array configurations or different operating conditions.

Although example processing systems have been described in the figures herein, implementations of the subject matter and the functional operations described herein may be implemented in other types of digital electronic circuitry, or in computer software, or hardware, including the structures disclosed in this specification and their structural equivalents, or in combinations of one or more of them.

Embodiments of the subject matter and the operations described herein may be implemented in digital electronic circuitry, or in computer software, or hardware, including the structures disclosed in this specification and their structural equivalents, or in combinations of one or more of them. Embodiments of the subject matter described herein may be implemented as one or more computer programs, e.g., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.
Clause 1. An apparatus comprising at least one processor and a memory storing instructions that are operable, when executed by the at least one processor, to cause the apparatus to: determine, based on an audio stream captured by at least one audio capture device of a microphone array, audio localization data associated with a source of interest within an environment.
Clause 2. The apparatus of clause 1, wherein the instructions are further operable to cause the apparatus to: generate, based on applying a defined elevation angle correction for the microphone array to the audio localization data, tuned audio localization data for the source of interest.
Clause 3. The apparatus of any one of the foregoing clauses, wherein the instructions are further operable to cause the apparatus to: determine, based on the tuned audio localization data, audio source tracking data for the source of interest.
Clause 4. The apparatus of any one of the foregoing clauses, wherein the instructions are further operable to cause the apparatus to: output the audio source tracking data to an output device communicatively coupled to the microphone array.
Clause 5. The apparatus of any one of the foregoing clauses, wherein the instructions are further operable to cause the apparatus to: apply temporal smoothing to the audio source tracking data to generate updated audio source tracking data for the source of interest.
Clause 6. The apparatus of any one of the foregoing clauses, wherein the instructions are further operable to cause the apparatus to: compare the audio localization data to historical audio localization data associated with the source of interest to determine a predicted most frequent location for the source of interest.
Clause 7. The apparatus of any one of the foregoing clauses, wherein the instructions are further operable to cause the apparatus to: generate the updated audio source tracking data based on the predicted most frequent location for the source of interest.
Clause 8. The apparatus of any one of the foregoing clauses, wherein the instructions are further operable to cause the apparatus to: assign the source of interest to a particular cluster within the environment based on the tuned audio localization data.
Clause 9. The apparatus of any one of the foregoing clauses, wherein the particular cluster is a previously determined cluster selected from a plurality of clusters for the environment.
Clause 10. The apparatus of any one of the foregoing clauses, wherein the particular cluster comprises a group of data points associated with a region within the audio environment.
Clause 11. The apparatus of any one of the foregoing clauses, wherein the instructions are further operable to cause the apparatus to: remove the particular cluster from the plurality of clusters in response to the particular cluster being included in the plurality of clusters for a defined interval of time.
Clause 12. The apparatus of any one of the foregoing clauses, wherein the audio localization data comprises time difference of arrival information.
Clause 13. The apparatus of any one of the foregoing clauses, wherein the audio source tracking data comprises a set of coordinates with respect to the microphone array.
Clause 14. The apparatus of any one of the foregoing clauses, wherein the set of coordinates comprises Cartesian coordinates or spherical coordinates that identify the source of interest within the environment in real time.
Clause 15. The apparatus of any one of the foregoing clauses, wherein the defined elevation angle correction comprises a defined value for the microphone array that compensates for potential error in an elevation angle estimation associated with the audio localization data.
Clause 16. The apparatus of any one of the foregoing clauses, wherein the defined elevation angle correction is based on a predetermined relationship between original elevation angles and corrected elevation angles for the microphone array.
Clause 17. The apparatus of any one of the foregoing clauses, wherein the output device is a camera device.
Clause 18. The apparatus of any one of the foregoing clauses, wherein the instructions are further operable to cause the apparatus to: transmit the audio source tracking data to a camera control system of the camera device to enable control of the camera device based on the audio source tracking data.
Clause 19. The apparatus of any one of the foregoing clauses, wherein the control of the camera device enables modification of camera framing based on the audio source tracking data.
Clause 20. A computer-implemented method comprising steps in accordance with any one of the foregoing clauses.
Clause 21. A computer program product, stored on a computer readable medium, comprising instructions that, when executed by one or more processors of the audio signal processing apparatus, cause the one or more processors to perform one or more operations related to any one of the foregoing clauses.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus comprising at least one processor and a memory storing instructions that are operable, when executed by the at least one processor, to cause the apparatus to:
determine, based on an audio stream captured by at least one audio capture device of a microphone array, audio localization data associated with a source of interest within an environment;
generate, based on applying a defined elevation angle correction for the microphone array to the audio localization data, tuned audio localization data for the source of interest;
determine, based on the tuned audio localization data, audio source tracking data for the source of interest; and
output the audio source tracking data to an output device communicatively coupled to the microphone array.

2. The apparatus of claim 1, wherein the instructions are further operable to cause the apparatus to:
apply temporal smoothing to the audio source tracking data to generate updated audio source tracking data for the source of interest.

3. The apparatus of claim 2, wherein the instructions are further operable to cause the apparatus to:
compare the audio localization data to historical audio localization data associated with the source of interest to determine a predicted most frequent location for the source of interest; and
generate the updated audio source tracking data based on the predicted most frequent location for the source of interest.

4. The apparatus of claim 1, wherein the instructions are further operable to cause the apparatus to:
assign the source of interest to a particular cluster within the environment based on the tuned audio localization data.

5. The apparatus of claim 4, wherein the particular cluster is a previously determined cluster selected from a plurality of clusters for the environment.

6. The apparatus of claim 4, wherein the particular cluster comprises a group of data points associated with a region within an audio environment.

7. The apparatus of claim 5, wherein the instructions are further operable to cause the apparatus to:
remove the particular cluster from the plurality of clusters in response to the particular cluster being included in the plurality of clusters for a defined interval of time.

8. The apparatus of claim 1, wherein the audio localization data comprises time difference of arrival information.

9. The apparatus of claim 1, wherein the audio source tracking data comprises a set of coordinates with respect to the microphone array.

10. The apparatus of claim 9, wherein the set of coordinates comprises Cartesian coordinates or spherical coordinates that identify the source of interest within the environment in real time.

11. The apparatus of claim 1, wherein the defined elevation angle correction comprises a defined value for the microphone array that compensates for potential error in an elevation angle estimation associated with the audio localization data.

12. The apparatus of claim 1, wherein the defined elevation angle correction is based on a predetermined relationship between original elevation angles and corrected elevation angles for the microphone array.

13. The apparatus of claim 1, wherein the output device is a camera device.

14. The apparatus of claim 13, wherein the instructions are further operable to cause the apparatus to:
transmit the audio source tracking data to a camera control system of the camera device to enable control of the camera device based on the audio source tracking data.

15. The apparatus of claim 14, wherein the control of the camera device enables modification of camera framing based on the audio source tracking data.

16. A computer-implemented method comprising:
determining, based on an audio stream captured by at least one audio capture device of a microphone array, audio localization data associated with a source of interest within an environment;
generating, based on applying a defined elevation angle correction for the microphone array to the audio localization data, tuned audio localization data for the source of interest;
determining, based on the tuned audio localization data, audio source tracking data for the source of interest; and
outputting the audio source tracking data to an output device communicatively coupled to the microphone array.

17. The computer-implemented method of claim 16, further comprising:
applying temporal smoothing to the audio source tracking data to generate updated audio source tracking data for the source of interest;
comparing the audio localization data to historical audio localization data associated with the source of interest to determine a predicted most frequent location for the source of interest; and
generating the updated audio source tracking data based on the predicted most frequent location for the source of interest.

18. The computer-implemented method of claim 16, further comprising:
assigning the source of interest to a particular cluster within the environment based on the tuned audio localization data, wherein the particular cluster is a previously determined cluster selected from a plurality of clusters for the environment; and
removing the particular cluster from the plurality of clusters in response to the particular cluster being included in the plurality of clusters for a defined interval of time.

19. The computer-implemented method of claim 16, further comprising:
transmitting the audio source tracking data to a camera control system of the camera device to enable control of the camera device based on the audio source tracking data.

20. A computer program product, stored on a computer readable medium, comprising instructions that, when executed by one or more processors of an apparatus, cause the one or more processors to:
determine, based on an audio stream captured by at least one audio capture device of a microphone array, audio localization data associated with a source of interest within an environment;
generate, based on applying a defined elevation angle correction for the microphone array to the audio localization data, tuned audio localization data for the source of interest;
determine, based on the tuned audio localization data, audio source tracking data for the source of interest; and
output the audio source tracking data to an output device communicatively coupled to the microphone array.
